(19) United States
(12) Patent Application Publication
(10) Pub. No.: US 2006/0262806 A1
(43) Pub. Date: Nov. 23, 2006

(54) System and method for data delivery

(76) Inventor: Imed Bouazizi, Tampere (FI)

Correspondence Address: MORGAN & FINNEGAN, L.L.P., 3 World Financial Center, New York, NY, 10281-2101, US

(21) Appl. No.: 11/132,554

(22) Filed: May 19, 2005

(51) Int. Cl. H04L 12/413

(52) U.S. Cl. 370/448; 370/338

(57) ABSTRACT

Systems and methods applicable, for instance, in data delivery. For example a service operator server and/or other computer might act to determine which of point-to-point repair mode and point-to-multipoint repair mode should be employed in the case where one or more receivers do not correctly receive dispatched data. As another example, the service operator server and/or other computer might calculate one or more estimates, request one or more values from one or more repair servers, and/or provide to one or more repair servers one or more directives regarding repair mode to be employed.

### FIELD OF INVENTION

This invention relates to systems and methods for data delivery.

### BACKGROUND INFORMATION

In recent times, there has been an increase in the use of data delivery. For example, many users have come to prefer data delivery (e.g., Digital Video Broadcasting: Handhelds (DVB-H) Internet Protocol Datacasting (IPDC) data delivery) to other sources of information, entertainment, data, and/or the like.

Accordingly, there may be interest in technologies applicable, for instance, in data delivery.

### SUMMARY OF THE INVENTION

According to embodiments of the present invention there are provided systems and methods applicable, for instance, in data delivery.

For example, in various embodiments a service operator server and/or other computer might act to determine which of point-to-point repair mode and point-to-multipoint repair mode should be employed in the case where one or more receivers do not correctly receive dispatched data.

The service operator server and/or other computer might, in various embodiments, calculate one or more estimates, request one or more values from one or more repair servers, and/or provide to one or more repair servers one or more directives regarding repair mode to be employed.

### BRIEF DESCRIPTION OF THE DRAWINGS

FIG. 1 shows exemplary steps involved in service operator operations according to various embodiments of the present invention.

FIG. 2 shows further exemplary steps involved in service operator operations according to various embodiments of the present invention.

FIG. 3 shows exemplary steps involved in user operations according to various embodiments of the present invention.

FIG. 4 shows an exemplary computer.

FIG. 5 shows a further exemplary computer.

### DETAILED DESCRIPTION OF THE INVENTION

General Operation

According to embodiments of the present invention there are provided systems and methods applicable, for instance, in data delivery.

For example, in various embodiments a service operator server and/or other computer might act to determine which of point-to-point repair mode and point-to-multipoint repair mode should be employed in the case where one or more receivers do not correctly receive data dispatched via Digital Video Broadcasting: Handhelds (DVB-H) Internet Protocol Datacasting (IPDC) Digital Multimedia Broadcast-Terrestrial (DMB-T), MediaFLO (Forward Link Only), and/or the like.

The service operator server and/or other computer might, in various embodiments, calculate one or more estimates (e.g., number of receivers that did not receive a certain portion of data, loss percentages, and/or repair mode effectiveness), request one or more values (e.g., number of repair requests received) from one or more repair servers, and/or provide to one or more repair servers one or more directives regarding repair mode to be employed.

Various aspects of the present invention will now be discussed in greater detail.

Service Operator Operations

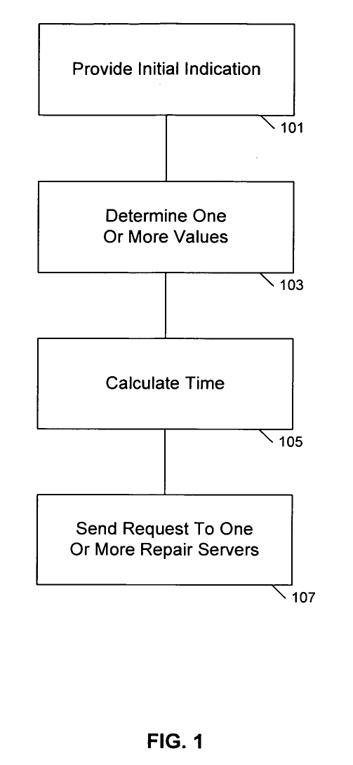

With respect to FIG. 1 it is noted that, according to various embodiments of the present invention, a service operator server and/or other computer might provide initial indication to one or more repair servers employed in Digital Video Broadcasting: Handhelds (DVB-H) Internet Protocol Datacasting (IPDC) Digital Multimedia Broadcast-Terrestrial (DMB-T), MediaFLO (Forward Link Only), and/or the like that point-to-point repair mode (e.g., employing Universal Mobile Telecommunications Service (UMTS) and/or General Packet Radio Service (GPRS)) should be employed in the case where one or more receivers (e.g., mobile nodes) do not correctly receive data (step 101). Such initial indication might, for instance, be dispatched in a manner employing Simple Object Access Protocol (SOAP), Java Messaging Service (JMS), and/or Remote Method Invocation (RMI).

It is noted that, in various embodiments, such initial indication might not be provided. Such might be the case, for instance, where employing point-to-point repair mode is set (e.g., by a manufacturer, system administrator, and/or service operator) as default repair server behavior.

The service operator server and/or other computer might, in various embodiments, determine one or more values corresponding to a given data set (e.g., a file and/or set of packets) (step 103). Such values might, for example, include end of data set transmission time tₑ, back-off offset time tₒ and/or back-off window T. The service operator server and/or other computer might then, for example, calculate a time:

$${t}_{e} + {t}_{0} + α \cdot T , \\ wherein \text{:}$$

$$α = \frac{t}{T} ,$$

with t being the time since start of back-off window (step 105).

In various embodiments, the service operator server and/or other computer might send a request to one or more repair servers at the calculated time (step 107). The request might, for instance, indicate that repair servers should provide to the service operator server and/or other computer indication of number of repair requests so far received for the data set. Such a request and/or responses thereto might, for example, be dispatched in a manner employing SOAP, JMS, and/or RMI.

A repair server receiving the request might, for instance, provide the requested value. In various embodiments, such a repair server might alternately or additionally calculate an estimate N of the total number of repair requests that it will receive for a given source block or encoding symbol of the given data set (e.g., for a complete request window):

$$N = \frac{n}{α} \cdot r ,$$

where n is the number of repair requests so far received for the data set by one repair server, and r is the number of repair servers. It is noted that, in various embodiments, N might alternately or additionally be computed by the service operator server and/or other computer. It is further noted that, in various embodiments, such calculation of N might not be employed for a first few time units (e.g., seconds) of a repair window. For instance, such calculation of N might not be employed for a first 10 seconds of a repair window. Such might, perhaps, lead to increased accuracy.

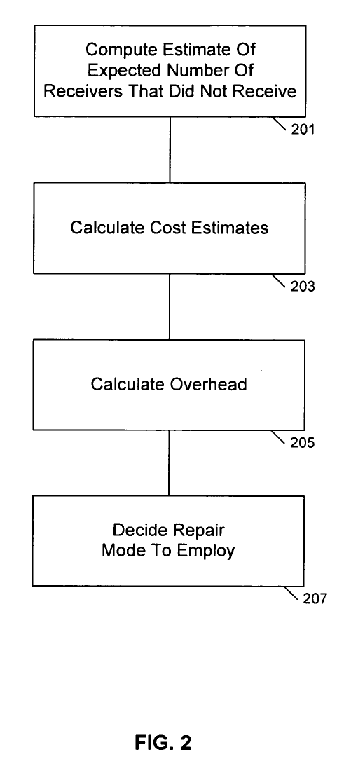

The service operator server and/or other computer might, for example, estimate a value β, where β is the fraction of receivers that have a return channel and are able and/or willing to send a repair request. With respect to FIG. 2 it is noted that the service operator server and/or other computer might employ β, for instance in computing an estimate Nₜ of expected number of receivers that did not receive a certain portion of the data set:

$${N}_{t} = \frac{N}{β}$$

(step 201). It is noted that, in various embodiments, β might be calculated as:
β=M·(1−α),
where M is the anticipated total number of receivers that can request repair.

The service operator server and/or other computer might, as further examples, calculate an estimate cᵤ of the cost of transporting a quantity of data (e.g., an octet) over the point-to-point channel being employed (e.g., GPRS or UMTS), and/or calculate an estimate cm of the cost of transporting a quantity of data (e.g., an octet) over the point-to-multipoint channel being employed (e.g., DVB-H) (step 203).

As yet another example, the service operator server and/or other computer might calculate an estimate sᵤ of point-to-point (e.g., GPRS or UMTS) overhead in terms of a quantity of data (e.g., octets) that is applicable as an estimate for point-to-point overhead for a repair request and also as an estimate for point-to-point overhead for a redirection response (step 205).

As a further example, the service operator server and/or other computer might calculate an estimate sₘ of point-to-multipoint (e.g., DVB-H) overhead in terms of a quantity of data (e.g., octets) for a session announcement for a point-to-multipoint (e.g., DVB-H) repair session (step 205).

The service operator server and/or other computer might, for example, calculate an estimate p of point-to-multipoint repair session (e.g., DVB-H repair session) loss ratio. In various embodiments, p might be calculated as:

$$p = \frac{number\_of \_recievers \_with \_unsuccessful \_reception}{total\_number \_of \_recievers} .$$

As yet another example, the service operator server and/or other computer might calculate an estimate of efficiency (e.g., number of receivers with successful reception per cost unit) for each of point-to-point repair mode and point-to-multipoint repair mode. Such efficiency might, for instance, be calculated as:

$$E = \frac{{N}_{s}}{C} ,$$

where C is total cost for a repair mode and Nₛ is number of successful receptions for a repair mode (e.g., number of receivers with successful data set receptions). Such effectiveness might, in various embodiments, be calculated for a point in time within the back-off window.

It is noted that, in various embodiments, number of successful receptions for point-to-point repair mode and/or number of successful receptions for point-to-multipoint repair mode may be estimated. It is further noted that, in various embodiments, cost of point-to-point repair mode and/or cost of point-to-multipoint repair mode may be estimated. Such a cost estimate for a repair mode might, perhaps, be thought of as a cost estimate for selection of the repair mode.

The service operator server and/or other computer might, for example, calculate:

$$\frac{{N}_{ptp}}{{C}_{ptp}} \leq \frac{{N}_{ptm}}{{C}_{ptm}} ,$$

where Nₚₜₚ is the number of successful receptions for the point-to-point repair mode, Nₚₜₘ is the number of successful receptions for the point-to-multipoint repair mode, Cₚₜₚ is the estimated total cost for the point-to-point repair mode, and Cₚₜₘ is the estimated total cost for the point-to-multipoint repair mode. The service operator server and/or other computer might, in various embodiments, consider such calculation in deciding repair mode to employ (step 207).

In the case where the service operator server and/or other computer calculates the above to be true (that is in the case where the left half of the above is found to be less than or equal to the right half), the service operator server and/or other computer might, in various embodiments, decide that point-to-point repair mode (e.g., GPRS or UMTS repair mode) should be employed.

In the case where the service operator server and/or other computer calculates the above to be false (that is in the case where the left half of the above is greater than the right half), the service operator server and/or other computer might, in various embodiments, decide that point-to-multipoint repair mode (e.g., DVB-H repair mode) should be employed.

It is noted that, in various embodiments, the above might be calculated for each of multiple repair servers. Point-to-point repair mode might, for instance, be employed for all repair servers in the case where the above was calculated to be true for one or more repair servers. It is further noted that, in various embodiments, in the case where there are multiple repair servers raw data might be collected and employed in decision making as to repair mode to be employed, with N perhaps being considered to be the sum of individual N/α's. It is additionally noted that, in various embodiments, in the case where there are multiple repair servers various combinations of individual N/α's might be employed for decision making as to repair mode to be employed.

Raw data collection and/or decision making as to repair mode to be employed may, in various embodiments, be distributed among multiple servers and/or other computers, with calculation of the above perhaps substituting Nₜ for (Nₜ−n). In such embodiments, Nₜ might be considered to be the number of future requests that are expected within the window, Nₜ·(1−p) might be considered to be the number of expected successful repairs after point-to-multipoint resend, and/or Nₜ·p might be considered to be the number of unsatisfied recipients.

In various embodiments, p might be viewed as being data dependent (e.g., a 10 MB resend might be considered to be more likely to leave unresolved receivers than a resend of 1 kB. It is noted that N·cᵤ·sᵤ might, in various embodiments, be considered to be cost of repair of all requests when original point-to-multipoint is always dropped by all clients during the repair window. Such might, perhaps, assume that all clients will request and that announcement of a point-to-multipoint repair will not silence a proportion. Such a proportion might, perhaps, be less than Nₜ (e.g., due to time lag between the decision and sending of the announcement but some proportion of receivers not receiving the announcement).

It is additionally noted that, the denominator of the above might, in various embodiments, be written so as to separate it into terms such as, for instance, “point-to-point cost”, “point-to-multipoint announcement latency cost”, and “point-to-multipoint cost”. Accordingly, for example, “point-to-point cost” might be n·cᵤ·(s+sᵤ). As another example, “point-to-multipoint announcement latency cost” might be L·cᵤ·(s+sᵤ) (for the case where point-to-point is served by point-to-point responses after decision is made) or L·cᵤ·sᵤ (for the case where redirection to a point-to-multipoint is done after decision is made).

L might, for instance, be considered to be the expected number of client requests between the decision and the end of the window tₑ+ tₒ+T. In various embodiments, if recipients stop sending repair requests once decision is made, L might be considered to be zero. Moreover, in various embodiments in the case where no announcement about the decision is sent or received, L might be considered to be Nₜ Alternately in the case where no announcement about the decision is sent or received, Nₜ might be considered to be:
Nₜ·(χ)+Nₜ·q,
where χ is time between decision and announcement reception including paging latency, and q is the probability that a receiver will not receive the announcement. In various embodiments, in the case where the announcement is sent more than once, such might be expressed in more detail (e.g., in view of probabilities for each announcement, the number of announcements, and/or the time between announcements).

It is noted that, in various embodiments, other than the above might be calculated by the service operator server and/or other computer in such decision. For example, a service operator server and/or other computer might use different formula for estimating the effectiveness (e.g., cost per successful data reception) of point-to-point repair mode and/or point-to-multipoint repair mode. For example, the service operator server and/or other computer might, in various embodiments, calculate:

$${c}_{u} \cdot ( s + {s}_{u} ) \leq \frac{( n \cdot {c}_{u} \cdot s + N \cdot {c}_{u} \cdot {s}_{u} + ( s + {s}_{m} ) \cdot {c}_{m} )}{( {N}_{t} - n ) \cdot ( 1 - p ) + n} ,$$

where s is amount of data (e.g., in terms of octets) to be transmitted in view of data not correctly received by receivers. In various embodiments, in the case where the service operator server and/or other computer calculated the above to be true it might decide that point-to-point repair mode should be employed, and in the case where it calculated the above to be false it might decide that point-to-multipoint repair mode should be employed.

The service operator server and/or other computer might, for example, inform one or more repair servers of its decision. Such functionality might be implemented in a number of ways. For example, SOAP, JMS, and/or RMI might be employed. It is noted that, in various embodiments, such informing might only be performed in the case where it was determined that point-to-multipoint repair mode should be employed. Such might be the case, for instance, where employing point-to-point repair mode is set as default repair server behavior.

In various embodiments, where it is decided that point-to-multipoint repair mode should be employed the service operator server and/or other computer might, for instance, schedule a point-to-multipoint session to transport respective data.

It is noted that, in various embodiments, one or more servers (e.g., file delivery servers) may update their associated delivery procedure descriptions by, for instance, sending updates in-band and/or out-of-band of a corresponding initial data set delivery session (e.g., a DVB-H IPDC data set delivery session). The one or more servers might, for instance, use the same channels, different channels, and/or different data set delivery sessions for delivery of point-to-multipoint repair responses. It is further noted that effectiveness might, in various embodiments, be considered as total cost per number of successful receptions and/or satisfied receivers.

It is additionally noted that, in various embodiments, via various operations discussed herein more effective usage of available data transmission channels, and/or more optimal repair mode selection (e.g., in view of network cost and number of satisfied clients) may be achieved. It is further noted that, in various embodiments, receivers lacking return channel capabilities and/or having users unwilling to send repair requests might benefit from repair requests and/or point-to-multipoint responses of others.

It is noted that, in various embodiments, at the start of a file delivery session, a server and/or other computer may indicate to receivers the existence of a point-to-point repair session and/or channel. Receivers might, for instance, join the repair session after a data set delivery (e.g., a file delivery) has ended. The receivers might, for example, dispatch point-to-point repair requests at random time instances. In the case where decision to employ point-to-multipoint repair mode is made the decision might, for example, be signaled to the receivers as a redirect response to a repair request and/or by sending a File Delivery Table (FDT) with an updated expiry timer to the point-to-multipoint repair session.

The service operator server and/or other computer might, in various embodiments, base its choice of the repair mode on an efficiency metric. The efficiency of a repair mode might, for example, be calculated as:

$$E = \frac{number\_of \_recievers \_with \_successful \_reception}{cost\_of \_transmission \_of \_repair \_data} .$$

The service operator server and/or other computer might, for example, estimate both parameters for the point-to-point and the point-to-multipoint repair modes separately. The service operator server and/or other computer might, for instance, decide to schedule a point-to-multipoint repair session for a specific file in the case where it finds the point-to-multipoint repair mode to be more efficient.

The service operator server and/or other computer might, for example, estimate the cost cᵤ for the transmission of a single quantity of data (e.g., an octet) over the point-to-point (e.g., GPRS or UMTS) network. As another example, the cost cm for the transmission of a single quantity of data (e.g., an octet) over the point-to-multipoint (e.g., DVB-H) network may be calculated. As yet another example, the service operator server and/or other computer might estimate the expected number of repair requests, the amount of data exchanged over the point-to-point network, and/or the amount of data exchanged over the point-to-multipoint network.

In various embodiments, after the start of a repair session (e.g., after data set transmission has ended), receivers might need to wait for a back-off offset time and then send their repair requests randomly within the random time period. The service operator server and/or other computer might, for instance, select a value for a between 0 and 1. The service operator server and/or other computer might, for example, calculate a time instant:
tₑ+tₒ30 α·T_{random}_{_{—}}ₜᵢₘₑ_{_{—}}_{period}

The service operator server and/or other computer might, in various embodiments, act at the calculated time instant to contact one or more of the repair servers to get information about, for instance, the number of repair requests received n_{req}, the number of encoding symbols requested n_{sym}, and/or the number of unique receivers which will send repair requests n_{recv}. The service operator server and/or other computer might, in various embodiments, consider repair requests to be uniformly randomly distributed over time and/or over repair servers, and may, for example, calculate estimates for expected total number of requests N_{req}, expected total number of requested symbols N_{sym}, and/or the expected total number of unique receivers sending a repair request N_{recv}:

$${N}_{req} = \frac{{n}_{req}}{α} \cdot r$$

$${N}_{sym} = \frac{{n}_{sym}}{α} \cdot r$$

$${N}_{recv} = \frac{{n}_{recv}}{α} \cdot r ,$$

where r is the number of repair servers for the current file delivery session. In various embodiments, the total cost for point-to-point repair mode might then be estimated as Cₚₜₚ:
Cₚₜₚ=cᵤ·N_{sym}·s_{sym}+cᵤ·N_{req}·s_{req}
where s_{sym} and s_{req} are the size of an encoding symbol and the overhead of a repair request respectively.

It is noted that, in various embodiments, in the case of point-to-multipoint repair mode, the service operator server and/or other computer might, for instance, redirect receivers to the point-to-multipoint repair session after the decision has been made (e.g., after time t). In such a case, for example, the repair mode might be point-to-point before time t, and point-to-multipoint after time t. It might, in various embodiments, be assumed that receivers will still send their point-to-point repair requests up to the end of the repair time. Moreover, in various embodiments it might be assumed that the point-to-multipoint repair session will contain the whole data set (e.g., the whole file) to achieve complete reception. Accordingly, for instance, the cost for point-to-multipoint repair might be calculated as Cₚₜₘ:
Cₚₜₘ=cₘ·(S+sₐₙ)+cᵤ·N_{req}·s_{req}+cᵤ·n_{sym}·s_{ym}
where S is the size of the data set and sₐₙ is the size of the announcement session.

According to various embodiments, the service operator server and/or other computer might estimate the number of receivers that were able to completely recover a given data set (e.g., file) after a repair session. For the point-to-point repair case, the service operator server and/or other computer might, in various embodiments, assume that all receivers that did send repair requests will be able to recover the data set. Accordingly, in various embodiments, for the point-to-point repair mode N_{recv} receivers might be thought to be able to recover the file:
numer_of_receivers_with_successful_receptionₚₜₚ=N_{recv}

However, in various embodiments, there may be receivers that don't have a point-to-point connection and/or unwilling to use it. The service operator server and/or other computer might, for example, estimate the fraction of these receivers by (1−β), where β is between 0 and 1. When using the point-to-multipoint repair mode these receivers might, in various embodiments, be able to have the opportunity to recover the data sets. However, in various embodiments there may still be a fraction of the receivers that are still not able to recover the data set after the point-to-multipoint repair session. The fraction might, in various embodiments, be dependent on the average loss rate p. Accordingly the service operator server and/or other computer might, for example, calculate an estimate of the total number of receivers recovering the file after point-to-multipoint repair as:

$$numer\_of \_recievers \_with \_successful {\_reception}_{ptm} = {n}_{recv} + ( 1 - p ) \cdot ( \frac{{N}_{recv}}{β} - {n}_{recv} )$$

The service operator server and/or other computer might, in various embodiments, employ the cost and/or number of receivers with successful reception to calculate the cost per satisfied receiver. The service operator server and/or other computer might, for instance, then decide to use the repair mode with the least cost per satisfied receiver (e.g., representing the more efficient repair mode).

Moreover, it is noted that, in various embodiments, various estimates and/or values discussed herein may be updated periodically and/or according to one or more schedules (e.g., schedules established by a manufacturer, system administrator, and/or service operator). It is additionally noted that, in various embodiments, various operations and/or the like discussed herein may be performed by a plurality of service operator servers and/or other computers.

User Operations

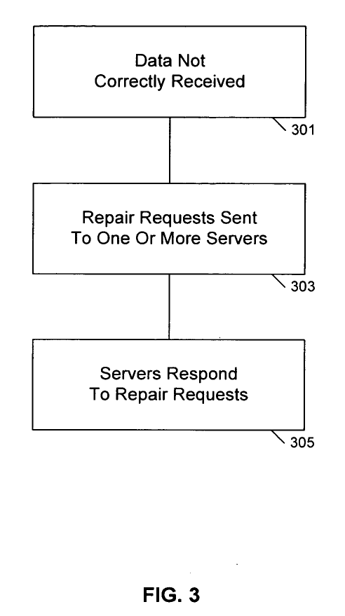

With respect to FIG. 3 it is noted that, according to various embodiments, in the case where a receiver does not correctly receive data during a data set delivery session (e.g., a DVB-H IPDC data set delivery session) (step 301), the receiver might, for instance, send one or more repair requests to one or more servers (step 303). Such a repair request might, perhaps, indicate data not correctly received.

Repair servers receiving the one or more repair requests might, for example, respond in a manner employing point-to-point repair mode (e.g., GPRS or UMTS repair mode). Accordingly the repair servers might, for instance, respond by dispatching to the receiver in a point-to-point manner some the missing data.

As another example, servers receiving the one or more repair requests might respond in a manner employing point-to-multipoint repair mode (e.g., DVB-H repair mode). Accordingly the repair servers might, for instance, respond by redirecting the receiver to a point-to-multipoint repair session, signaling a point-to-multipoint repair session via session announcement, and/or signaling a point-to-multipoint repair session in-band.

The responding of the servers in a manner employing point-to-point repair mode or in a manner employing point-to-multipoint repair mode might, in various embodiments, be in accordance with service operator server and/or other computer decision of the sort discussed above (step 305).

It is noted that, in various embodiments, indicated to receivers (e.g., via file delivery servers) may be lists of repair servers and/or back-off algorithm parameters. Moreover, in various embodiments, a receiver might randomly choose a repair server and/or a time instant within the back-off time window. Via such operation, repair requests might, perhaps, be uniformly distributed over repair servers and/or time.

Hardware and Software

Various operations and/or the like described herein may, in various embodiments, be executed by and/or with the help of computers. Further, for example, devices described herein may be and/or may incorporate computers. The phrases “computer”, “general purpose computer”, and the like, as used herein, refer but are not limited to a smart card, a media device, a personal computer, an engineering workstation, a PC, a Macintosh, a PDA, a portable computer, a computerized watch, a wired or wireless terminal, phone, communication device, node, and/or the like, a server, a network access point, a network multicast point, a network device, a set-top box, a personal video recorder (PVR), a game console, a portable game device, a portable audio device, a portable media device, a portable video device, a television, a digital camera, a digital camcorder, a Global Positioning System (GPS) receiver, a wireless personal sever, or the like, or any combination thereof, perhaps running an operating system such as OS X, Linux, Darwin, Windows CE, Windows XP, Windows Server 2003, Palm OS, Symbian OS, or the like, perhaps employing the Series 40 Platform, Series 60 Platform, Series 80 Platform, and/or Series 90 Platform, and perhaps having support for Java and/or Net.

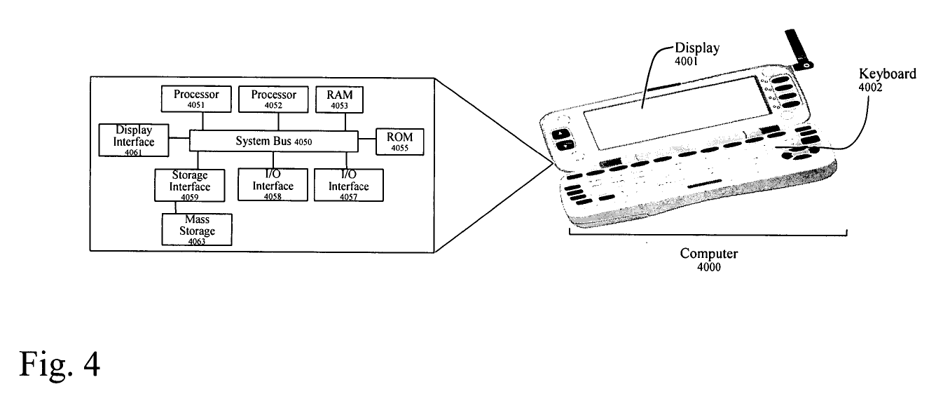

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Shown in FIG. 4 is an exemplary computer employable in various embodiments of the present invention. Exemplary computer 4000 includes system bus 4050 which operatively connects two processors 4051 and 4052, random access memory 4053, read-only memory 4055, input output (I/O) interfaces 4057 and 4058, storage interface 4059, and display interface 4061. Storage interface 4059 in turn connects to mass storage 4063. Each of I/O interfaces 4057 and 4058 may, for example, be an Ethernet, IEEE 1394, IEEE 1394b, IEEE 802.11a, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16x, IEEE 802.20, IEEE 802.15.3, ZigBee, Bluetooth, Ultra Wide Band (UWB), Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Multimedia Broadcast-Terrestrial (DMB-T), Terrestrial Digital Multimedia Broadcasting (T-DMB), MediaFLO (Forward Link Only), Digital Audio Broadcast (DAB), Digital Radio Mondiale (DRM), General Packet Radio Service (GPRS), Universal Mobile Telecommunications Service (UMTS), Global System for Mobile Communications (GSM), DVB-H (Digital Video Broadcasting: Handhelds), IrDA (Infrared Data Association), and/or other interface.

Mass storage 4063 may be a hard drive, optical drive, a memory chip, or the like. Processors 4051 and 4052 may each be a commonly known processor such as an IBM or Freescale PowerPC, an AMD Athlon, an AMD Opteron, an Intel ARM, an Intel XScale, a Transmeta Crusoe, a Transmeta Efficeon, an Intel Xenon, an Intel Itanium, an Intel Pentium, or an IBM, Toshiba, or Sony Cell processor. Computer 4000 as shown in this example also includes a touch screen 4001 and a keyboard 4002. In various embodiments, a mouse, keypad, and/or interface might alternately or additionally be employed. Computer 4000 may additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules might, for example, be programmed using languages such as Java, Objective C, C, C#, C++, Perl, Python, and/or Comega according to methods known in the art. Corresponding program code might be placed on media such as, for example, DVD, CD-ROM, memory card, and/or floppy disk. It is noted that any described division of operations among particular software modules is for purposes of illustration, and that alternate divisions of operation may be employed. Accordingly, any operations discussed as being performed by one software module might instead be performed by a plurality of software modules. Similarly, any operations discussed as being performed by a plurality of modules might instead be performed by a single module. It is noted that operations disclosed as being performed by a particular computer might instead be performed by a plurality of computers. It is further noted that, in various embodiments, peer-to-peer and/or grid computing techniques may be employed. It is additionally noted that, in various embodiments, remote communication among software modules may occur. Such remote communication might, for example, involve Simple Object Access Protocol (SOAP), Java Messaging Service (JMS), and/or Remote Method Invocation (RMI).

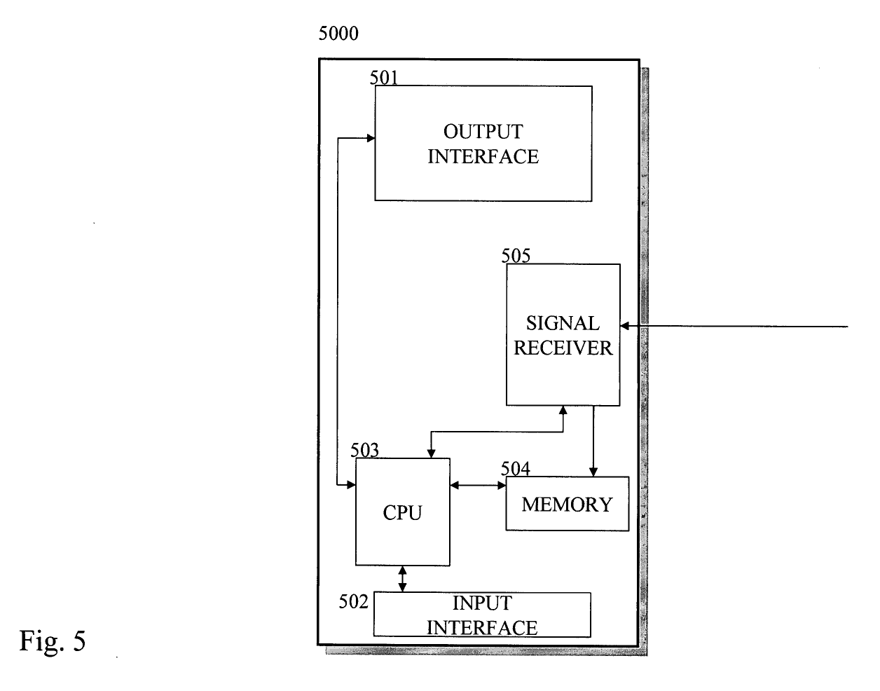

Shown in FIG. 5 is a block diagram of a terminal, an exemplary computer employable in various embodiments of the present invention. In the following, corresponding reference signs are applied to corresponding parts. Exemplary terminal 5000 of FIG. 5 comprises a processing unit CPU 503, a signal receiver 505, and a user interface (501, 502). Signal receiver 505 may, for example, be a single-carrier or multi-carrier receiver. Signal receiver 505 and the user interface (501, 502) are coupled with the processing unit CPU 503. One or more direct memory access (DMA) channels may exist between multi-carrier signal terminal part 505 and memory 504. The user interface (501, 502) comprises a display and a keyboard to enable a user to use the terminal 5000. In addition, the user interface (501, 502) comprises a microphone and a speaker for receiving and producing audio signals. The user interface (501, 502) may also comprise voice recognition (not shown).

The processing unit CPU 503 comprises a microprocessor (not shown), memory 504 and possibly software. The software can be stored in the memory 504. The microprocessor controls, on the basis of the software, the operation of the terminal 5000, such as receiving of a data stream, tolerance of the impulse burst noise in data reception, displaying output in the user interface and the reading of inputs received from the user interface. The hardware contains circuitry for detecting signal, circuitry for demodulation, circuitry for detecting impulse, circuitry for blanking those samples of the symbol where significant amount of impulse noise is present, circuitry for calculating estimates, and circuitry for performing the corrections of the corrupted data.

Still referring to FIG. 5, alternatively, middleware or software implementation can be applied. The terminal 5000 can, for instance, be a hand-held device which a user can comfortably carry. The terminal 5000 can, for example, be a cellular mobile phone which comprises the multi-carrier signal terminal part 505 for receiving multicast transmission streams. Therefore, the terminal 5000 may possibly interact with the service providers.

It is noted that various operations and/or the like described herein may, in various embodiments, be implemented in hardware (e.g., via one or more integrated circuits). For instance, in various embodiments various operations and/or the like described herein may be performed by specialized hardware, and/or otherwise not by one or more general purpose processors. One or more chips and/or chipsets might, in various embodiments, be employed. In various embodiments, one or more Application-Specific Integrated Circuits (ASICs) may be employed.

Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

What is claimed is:

1. A method, comprising:
calculating a time, wherein calculation takes into account an end of data set transmission time for a data set, a back-off offset time, and a back-off window;
sending, at the calculated time to one or more repair servers, a request for number of repair requests received;
determining one of point-to-point repair and point-to-multipoint repair to be a most effective repair mode; and
informing one or more repair servers of the determined most effective repair mode.

2. The method of claim 1, further comprising estimating a number of receivers that did not receive a certain portion of data.

3. The method of claim 1, further comprising estimating a point-to-point channel overhead.

4. The method of claim 1, further comprising estimating a point-to-multipoint channel overhead.

5. The method of claim 1, further comprising estimating a point-to-multipoint repair session loss percentage.

6. The method of claim 1, further comprising estimating number of successful data set receptions.

7. The method of claim 1, further comprising estimating a cost to transport a data unit over a point-to-point channel.

8. The method of claim 1, further comprising estimating a cost to transport a data unit over a point-to-multipoint channel.

9. The method of claim 1, further comprising estimating repair mode effectiveness.

10. The method of claim 1, wherein digital video broadcasting for handhelds point-to-multipoint is employed.

11. The method of claim 1, wherein universal mobile telecommunications service point-to-point is employed.

12. A method, comprising:
estimating a number of receivers that did not receive a certain portion of data;
estimating a point-to-point channel overhead;
estimating a point-to-multipoint channel overhead;
estimating a point-to-multipoint repair session loss percentage;
estimating number of successful receptions for point-to-point repair mode;
estimating number of successful receptions for point-to-multipoint repair mode;
estimating cost of point-to-point repair mode selection;
estimating cost of point-to-multipoint repair mode selection;
estimating repair mode effectiveness; and
determining one of point-to-point repair and point-to-multipoint repair to be a most effective repair mode.

13. The method of claim 12, further comprising estimating a cost to transport a data unit over a point-to-point channel.

14. The method of claim 12, further comprising estimating a cost to transport a data unit over a point-to-multipoint channel.

15. The method of claim 12, further comprising calculating a time, wherein calculation takes into account an end of data set transmission time for a data set, a back-off offset time, and a back-off window.

16. The method of claim 12, further comprising sending, at a calculated time to one or more repair servers, a request for number of repair requests received.

17. The method of claim 12, further comprising informing one or more repair servers of the determined most effective repair mode.

18. The method of claim 12, further comprising estimating a fraction of receivers that will send repair requests.

19. The method of claim 12, further comprising initially instructing one or more repair servers to employ point-to-point repair mode.

20. The method of claim 12, wherein digital video broadcasting for handhelds point-to-multipoint is employed.

21. The method of claim 12, wherein universal mobile telecommunications service point-to-point is employed.

22. A system, comprising:
a memory having program code stored therein; and
a processor disposed in communication with the memory for carrying out instructions in accordance with the stored program code;
wherein the program code, when executed by the processor, causes the processor to perform:
calculating a time, wherein calculation takes into account an end of data set transmission time for a data set, a back-off offset time, and a back-off window;
sending, at the calculated time to one or more repair servers, a request for number of repair requests received;
determining one of point-to-point repair and point-to-multipoint repair to be a most effective repair mode; and
informing one or more repair servers of the determined most effective repair mode.

23. The system of claim 22, wherein the processor further performs estimating a number of receivers that did not receive a certain portion of data.

24. The system of claim 22, wherein the processor further performs estimating a point-to-point channel overhead.

25. The system of claim 22, wherein the processor further performs estimating a point-to-multipoint channel overhead.

26. The system of claim 22, wherein the processor further performs estimating a point-to-multipoint repair session loss percentage.

27. The system of claim 22, wherein the processor further performs estimating number of successful data set receptions.

28. The system of claim 22, wherein the processor further performs estimating a cost to transport a data unit over a point-to-point channel.

29. The system of claim 22, wherein the processor further performs estimating a cost to transport a data unit over a point-to-multipoint channel.

30. The system of claim 22, wherein the processor further performs estimating repair mode effectiveness.

31. The system of claim 22, wherein digital video broadcasting for handhelds point-to-multipoint is employed.

32. The system of claim 22, wherein universal mobile telecommunications service point-to-point is employed.

33. A system, comprising:
a memory having program code stored therein; and
a processor disposed in communication with the memory for carrying out instructions in accordance with the stored program code;
wherein the program code, when executed by the processor, causes the processor to perform:
estimating a number of receivers that did not receive a certain portion of data;
estimating a point-to-point channel overhead;
estimating a point-to-multipoint channel overhead;
estimating a point-to-multipoint repair session loss percentage;
estimating number of successful receptions for point-to-point repair mode;
estimating number of successful receptions for point-to-multipoint repair mode;
estimating cost of point-to-point repair mode selection;
estimating cost of point-to-multipoint repair mode selection;
estimating repair mode effectiveness; and
determining one of point-to-point repair and point-to-multipoint repair to be a most effective repair mode.

34. The system of claim 33, wherein the processor further performs estimating a cost to transport a data unit over a point-to-point channel.

35. The system of claim 33, wherein the processor further performs estimating a cost to transport a data unit over a point-to-multipoint channel.

36. The system of claim 33, wherein the processor further performs calculating a time, wherein calculation takes into account an end of data set transmission time for a data set, a back-off offset time, and a back-off window.

37. The system of claim 33, wherein the processor further performs sending, at a calculated time to one or more repair servers, a request for number of repair requests received.

38. The system of claim 33, wherein the processor further performs informing one or more repair servers of the determined most effective repair mode.

39. The system of claim 33, wherein the processor further performs estimating a fraction of receivers that will send repair requests.

40. The system of claim 33, wherein the processor further performs initially instructing one or more repair servers to employ point-to-point repair mode.

41. The system of claim 33, wherein digital video broadcasting for handhelds point-to-multipoint is employed.

42. The system of claim 33, wherein universal mobile telecommunications service point-to-point is employed.

43. A server, comprising:
a memory having program code stored therein;
a processor disposed in communication with the memory for carrying out instructions in accordance with the stored program code; and
a network interface disposed in communication with the processor;
wherein the program code, when executed by the processor, causes the processor to perform:
estimating point-to-point repair mode effectiveness for a point in time within a back-off window;
estimating point-to-multipoint repair mode effectiveness for the point in time within the back-off window; and
determining one of point-to-point repair and point-to-multipoint repair to be a most effective repair mode.
